(19) United States
(12) Patent Application Publication
(10) Pub. No.: US 2008/0277002 A1
(43) Pub. Date: Nov. 13, 2008

(54) COUPLER

(76) Inventor: Paul Hendrixson, Cumming, GA (US)

Correspondence Address: GRAY ROBINSON, P.A., P.O. Box 2328, FT. LAUDERDALE, FL, 33303-9998, US

(21) Appl. No.: 11/745,473

(22) Filed: May 8, 2007

(51) Int. Cl. F16L 37/00

(52) U.S. Cl. 137/798

(57) ABSTRACT

This invention is directed to a coupler which comprises an actuator housing and a plunger housing each formed with a passageway for transmitting fluid entering an indwelling catheter to a collection bag. As the housings are connected together, a plunger located in the passageway of the plunger housing is moved from a closed position to an open position by an actuator mounted in the actuator housing in such a way that a seal is continuously maintained in the plunger housing to prevent the escape of fluids from its passageway. A quick-release locking mechanism maintains the two housings in a locked position when the plunger is in the open position, and may be easily activated to permit separation of the housings from one another when it is desired to empty or replace the collection bag.

### FIELD OF THE INVENTION

This invention relates to couplers, and, more particularly, to a quick-release coupler particularly adapted to connect a catheter to a collection bag in a bladder management system.

### BACKGROUND OF THE INVENTION

A variety of medical conditions require the use of collection bags to receive bodily fluids, which must be periodically emptied or replaced. For example, following surgery or due to certain medical conditions, many patients are provided with a Foley catheter or other type of indwelling catheter until such time as normal bladder function returns. The catheter is typically connected by tubing, or directly, to a collection bag. It is advantageous for the catheter or tubing to be quickly disconnected from the collection bag, with a minimum of effort and without leakage, in order to empty or replace the bag.

Coupling devices have been proposed for connecting catheters or tubing to collection bags in bladder management systems, and other medical applications in which bodily fluids must be collected, such as disclosed, for example, in U.S. Pat. Nos. 6,918,899; 6,706,027; 6,471,680; and 6,296,627. Each of these patents discloses a quick-disconnect coupler interposed between a collection bag and a catheter in a fluid collection system, allowing the bag to be removed from the system for emptying or replacement.

U.S. Pat. No. 5,496,300 to Hirsch et al teaches a bladder management system including a coupler comprising male and female coupling elements each having a valve located within a flow passageway extending through respective coupling elements. When the coupling elements are interconnected, both valves are moved to an open position allowing fluid to flow from the upstream side of the coupler, through the passageways in the coupling elements and then into a collection bag. A seal is created between the two coupling elements when they are connected, but a relatively long flow path exists between the seal and the inlets of the valves. Fluid may collect along this flow path, and leak out, after the coupling elements are separated.

### SUMMARY OF THE INVENTION

This invention is directed to a coupler which comprises an actuator housing and a plunger housing each formed with a passageway for transmitting fluid entering an indwelling catheter to a collection bag. As the housings are connected together, a plunger located in the passageway of the plunger housing is moved from a closed position to an open position by an actuator mounted in the actuator housing in such a way that a seal is continuously maintained in the plunger housing to prevent the escape of fluids from its passageway. A quick-release locking mechanism maintains the two housings in a locked position when the plunger is in the open position, and may be easily activated to permit separation of the housings from one another when it is desired to empty or replace the collection bag.

In the presently preferred embodiment, fluid from the catheter enters the inlet end of the passageway formed in the plunger housing. With the plunger in a closed position, a seal is created at the outlet end of the passageway to prevent leakage of fluid from the plunger housing. A second seal is mounted near the outlet end of the passageway which extends outwardly from the exterior surface of the plunger housing.

The actuator housing is movable relative to the plunger housing.

An inner section of the actuator housing slides along the exterior surface of the plunger housing and engages the second seal protruding from the exterior surface of the plunger housing. A seal is created at that interface throughout substantially the entire period of contact between the two housings. The actuator is located downstream within the passageway of the actuator housing such that it does not contact the leading end of the plunger until after a seal is formed between the inner section of the actuator housing and the exterior surface of the plunger housing. Consequently, when the actuator does move the plunger to an open position, unseated from the outlet end of the passageway in the plunger housing, the two housings are sealed together preventing the escape of any fluids from the plunger housing except into the passageway of the actuator housing.

The locking mechanism is coupled to the exterior surface of the plunger housing and is effective to maintain the two housings connected to one another while the plunger is in the open position. A release button of the locking mechanism allows the two housings to be separated from one another so that the collection bag may be emptied or replaced. In the course of separating the two housings from one another, the plunger moves to the closed position prior to disengagement of the inner section of the actuator housing from the seal on the exterior surface of the plunger housing. This ensures that any fluid within the plunger housing is captured and maintained within its passageway before the two housings are separated from one another, thus preventing dripping of fluid from the plunger housing when the two housings are connected to one another or separated.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is perspective view of the plunger housing and actuator housing separated from one another;

FIG. 2 is an elevational view of the coupler depicted in FIG. 1, with the housings separated;

FIG. 3 is a cross sectional view taken generally along line 3-3 of FIG. 2; and

FIG. 4 is a cross sectional view of the coupler similar to FIG. 3, except with the two housings assembled.

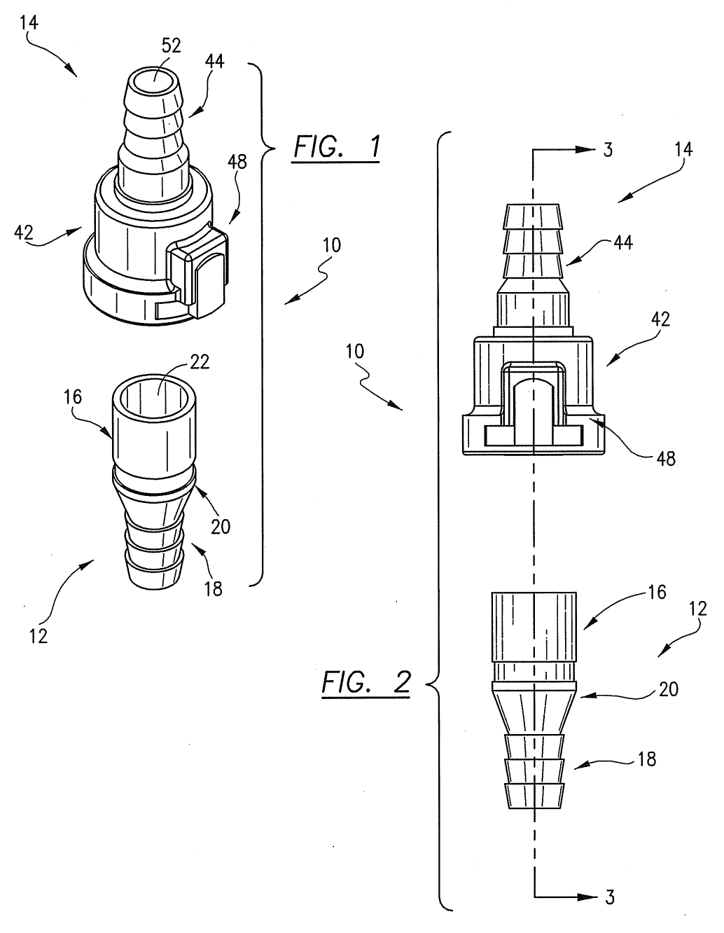

### DETAILED DESCRIPTION OF THE INVENTION

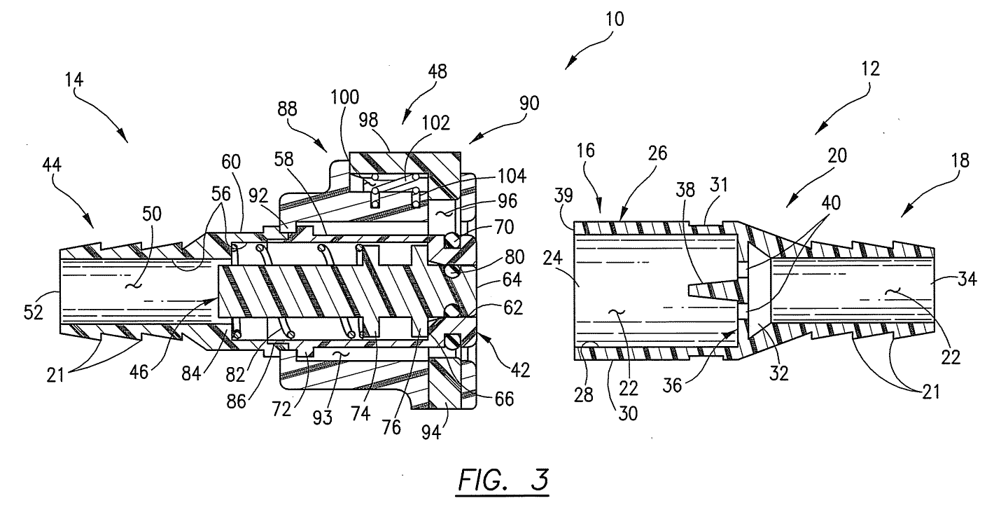

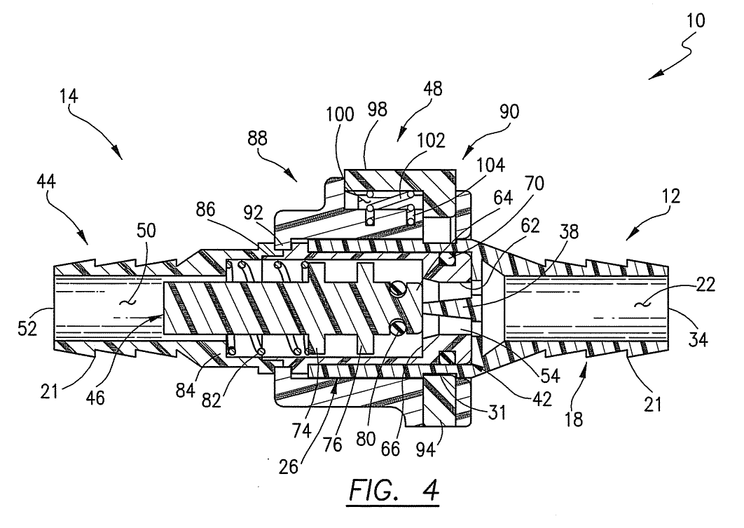

Referring now to the drawings, the coupler 10 of this invention includes an actuator housing 12 and a plunger housing 14 which may be releasably connected to one another preferably to interconnect a catheter with a collection bag in a bladder management system (not shown). For purposes of the present discussion, the terms “inner” and “outer” refer to an orientation in the longitudinal direction as depicted in FIGS. 3 and 4, i.e. “inner” refers to the center of such Figs. and “outer” refers to a location toward the edges of the sheet on which such Figs. are drawn. The terms “interior” and “exterior” refer to radially spaced locations in FIGS. 3 and 4, it begin understood that “interior” surfaces are located toward the center of the housings 12 and 14, as shown. Additionally, the terms “inlet” and “outlet” refer to the direction of fluid flow through the coupler 10, e.g. from the left to the right in the orientation of the coupler 10 depicted in FIGS. 3 and 4.

The actuator housing 12 comprises an inner section 16, a longitudinally spaced outer section 18 and a tapered section 20 between the inner and outer sections 16, 18. The outer section 18 includes a number of longitudinally spaced, protruding barbs 21 which engage tubing or the like to secure one side of the coupler 10 in place. The actuator housing 12 is formed with a passageway 22 having an inlet 24 at the inner section 16. The passageway 22 defines a generally cylindrical-shaped wall 26 with an interior surface 28 and an exterior surface 30. An annular recess 31 is formed in the inner section 16 which extends inwardly from the exterior surface 30 of the wall 26 toward the interior surface 28. The passageway 22 reduces in diameter through a transition area 32 along the tapered section 20 of actuator housing 12 to the outer section 18 where it terminates at an outlet 34. A disc 36 extends radially inwardly into the passageway 22 from the area where the inner and tapered sections 16, 20 meet. A plunger actuator 38 is mounted to the center of the disc 36, extending in a direction toward the inlet 24 of the passageway 22, and a number of bores 40 are formed in the disc 36 encircling the actuator 38. It should be noted, for purposes to become apparent below, that the actuator 38 is longitudinally spaced from the inlet 24 of the passageway 22 and the innermost edge 39 of the inner section 16 of the actuator housing 12.

The plunger housing 14 generally comprises an inner body 42, an outer body 44 and a plunger 46. A locking mechanism 48 is coupled to the plunger housing 14, as described in detail below. A passageway 50 extends through the plunger housing 14 having an inlet 52 at the outer body 44 and an outlet 54 at the inner body 42. See FIG. 4. The passageway 50 is defined by an interior surface 56 in the, plunger housing 14. The inner body 42 has an exterior surface 58 spaced from the interior surface 56, and the exterior surface 60 of the outer body 44 is formed with barbs 21 as in the outer section 18 of actuator housing 12.

As best seen in FIGS. 3 and 4, the inner body 42 has a reduced diameter at the outlet 54 of the passageway 50 forming an elongated seat 62 which receives the leading end 64 of the plunger 46, when the plunger 46 in the closed position as described below in connection with a discussion of the operation of the coupler 10. The seat 62 terminates at a shoulder 66 upstream from the outlet 54 of the passageway 50. A groove extends radially inwardly from the exterior surface 58 of the inner body 42, adjacent to the outlet end of the inner body 42, and this groove mounts an 0-ring 70 or similar seal. An annular ring 72 extends from the exterior surface 58 of the inner body 42 near its outer end.

The plunger 46 is formed with a pair of longitudinally spaced ribs 74 and 76, and a groove adjacent to its leading end 64. The groove mounts an 0-ring 80, or a similar seal, in position to engage and seal against the seat 62 at the outlet of the inner body 42. With the plunger 46 in the closed position 10 shown in FIG. 3, the rib 76 rests against the shoulder 66 of the inner body 42. A spring 82 extends along the exterior surface of the plunger 46 between the rib 74 and a shoulder 84 formed in the outlet end of the outer body 44 within the passageway 50. The longitudinal spacing between the rib 74 and shoulder 84 is chosen so that the spring 82 exerts sufficient force on the plunger 46 to 15 maintain it in the closed position.

The plunger housing 14 is assembled by placing the spring 82 over the plunger 46 and then inserting the leading end 64 of the plunger 46 into the outlet end of the inner body 42 so that the 0-ring 80 on the plunger 46 seals against the seat 62 of the inner body 42. The inner and outer bodies 42, 44 are then connected to one another, such as by adhesive or the like, along a joint 86 formed by mating annular surfaces at the ends of the bodies 42, 44.

The locking mechanism 48 comprises a lock collar 88 coupled to the inner body 42, and a release member 90 carried by the lock collar 88. The lock collar 88 extends around the inner body 42 of the plunger housing 14, and includes a radially inwardly projecting arm 92 affixed to the exterior surface 58 of the inner body 42 and the exterior surface 60 of the outer body 44 at the joint 86 between the two. An elongated, annular cavity 93 is formed between the lock collar 88 and exterior surface 58 of the inner body 42 which extends from the inner end of the inner body 42 toward the outer body 44. See FIG. 3. The release member 90 consists of an annular ring 94 carried within a slot 96 formed in the lock collar 88, and a button 98 extending generally perpendicularly to the ring 94. The button 98 slides within an opening 100 formed in the lock collar 88. A spring 102, located within the opening 100 and seated within an annular slot 104 in the lock collar 88, bears against the button 98 urging it radially outwardly as depicted in FIGS. 3 and 4. At least a portion of the annular ring 94 of the release member extends part way into the cavity 93 between the lock collar 88 and the exterior surface 58 of the inner body 42 as a result of the force exerted by spring 102 on the button 98.

### Operation of Coupler

The coupler 10 of this invention operates as follows. The outer body 44 of the plunger housing 14 is inserted into the interior of a catheter, tubing or the like (not shown) so that the barbs 21 on its exterior surface 60 engage the interior thereof. Similarly, the outer section 18 of the actuator housing 12 is coupled directly to a collection bag (not shown) or to tubing connected to such bag. With the actuator housing 12 and plunger housing 14 separated from one another, the spring 82 urges the plunger 46 to the closed position in which the O-ring 80 at the leading end 64 of the plunger 46 contacts and seals against the seat 62 formed in the inner body 42 at the outlet 54 of the passageway 50. Consequently, any fluid which may be present in the tubing or catheter to which the plunger housing 14 is connected will not leak from the plunger housing 14.

In order to connect the two housings 12, 14 to one another, and move the plunger 46 to an open position, the wall 26 of the inner section 16 of the actuator housing 12 is inserted into the cavity 93 formed between the locking mechanism 48 and the exterior surface 58 of the inner body 42 of the plunger housing 14. After a minimum amount of travel along the cavity 93, the interior surface 28 of the wall 26 engages and seals against the 0-ring 70 on the exterior surface 58 of the inner body 42 of the plunger housing 14. It is important to note that the plunger 46 is in the closed and sealed position at the time of contact between the wall 26 and 0-ring 70. Continued longitudinal movement of the actuator housing 12 relative to the plunger housing 14 causes the actuator 38 to engage the leading end 64 of the plunger 46. Such movement overcomes the force exerted by the spring 82 tending to close the plunger 46, and moves the plunger 46 to an open position, spaced from the seat 62, as shown in FIG. 4. With the plunger 46 in the open position, the passageway 50 in the plunger housing 14 communicates with the passageway 22 in the actuator housing 12 thus forming a flow path through the coupler 10 from the catheter to a collection bag.

As best seen in FIG. 4, the wall 26 of the inner section 16 of actuator housing 12 continues along the cavity 93 until the annular recess 31 formed in the exterior surface 30 of the inner section 16 of actuator housing 12 aligns with the annular ring 94 of the locking mechanism 48. At that point, the spring 102 urges the ring 94 into the recess 31 thus locking the actuator housing 12 and plunger housing 14 in position relative to one another. See bottom of FIG. 4. In the locked position of the two housings 12and 14, the plunger 46 is maintained in the open position.

When it is desired to disconnect the housings 12 and 14 from one another, the release button 98 is pressed radially inwardly which causes the annular ring 94 to disengage the recess 31 in the wall 26 of the inner section 16 of actuator housing 12, e.g. to move from a locked position to an unlocked position. This allows the inner section 16 of actuator housing 12 to be slid out of the cavity 93. As the actuator housing 12 is moved in a direction away from the plunger housing 14, the plunger 46 is urged in the same direction by the spring 82. As soon as the actuator 38 clears the outlet 54 of the passageway 50 in the plunger housing 14, the plunger 46 assumes its closed position with the O-ring 80 sealed against the seat 62 in the inner body 42 of plunger housing 14. At this juncture, the wall 26 of the inner section 16 of the actuator housing 12 remains sealed to the O-ring 70 on the exterior surface of the inner body 42 because of the longitudinal spacing between the actuator 38 and the innermost edge 39 of the inner section 16. This ensures that any fluid residing within the passageway 50 of the plunger housing 14 cannot escape as the housings 12 and 14 are disconnected from one another. The actuator housing 12 is then completely disengaged from the plunger housing 14 to permit a bag connected to the actuator housing 12 to be emptied or replaced. Fluid which entered the passageway 22 of the actuator housing 12 while the housings 12 and 14 were connected to one another would have already passed into a collection bag, which typically includes a flap valve at the inlet thereof to prevent fluid from exiting the bag at its inlet. After the collection bag is emptied or replaced, the housings 12 and 14 may be re-connected to one another as described above.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A coupler, comprising:
a first housing having an inner section, an outer section and a first passageway extending through said inner and outer sections, an actuator being mounted to one of said inner and outer sections within said first passageway;
a second housing having a first end, a second end opposite said first end, a second passageway extending between said first and second ends, an interior surface defining said second passageway, an exterior surface spaced from said interior surface, and a plunger movable within said second passageway between an open position and a closed position, a leading end of said plunger being sealed against said interior surface of said passageway at said first end of said second housing when in said closed position;
said inner section of said first housing being movable in sealing engagement along said exterior surface of said second housing in a direction from said first end toward said second end of said second housing, said actuator of said first housing contacting said leading end of said plunger in the course of movement of said first housing relative to said second housing to move said plunger to said open position thereby interconnecting said first passageway of said first housing with said second passageway of said second housing; and
a locking mechanism coupled to said exterior surface of said second housing, said locking mechanism being effective to releasably connect said first housing and said second housing to one another with said plunger in said open position.

2. The coupler of claim 1 in which said inner section of said first housing has a larger diameter than said outer section thereof, a transition area being formed in said passageway at the juncture of said inner and outer sections.

3. The coupler of claim 1 in which said actuator is mounted to a disc extending into said passageway of said first housing, said disc being formed with a number of bores.

4. The coupler of claim 1 in which said second housing is formed with an inner body and an outer body which are connected to one another, said second passageway extending through said inner and outer bodies and having an inlet in said outer body and an outlet in said inner body.

5. The coupler of claim 4 in which said leading end of said plunger mounts a seal which seats within said outlet of said second passageway.

6. The coupler of claim 4 in which said inner body is formed with a first shoulder adjacent said first end of said second housing, and said outer body is formed with a second shoulder spaced from said first shoulder.

7. The coupler of claim 6 in which said plunger is formed with a first radial projection which engages said first shoulder of said inner body when said plunger is in said closed position.

8. The coupler of claim 7 further including a spring extending along said plunger between said second shoulder of said outer body and a second radial projection of said plunger, said spring being effective to urge said plunger toward said closed position.

9. The coupler of claim 4 in which said inner and outer bodies collectively form said interior and exterior surfaces of said second housing, said inner body mounting a seal which extends outwardly from said exterior surface in position to engage and create a seal with said inner section of said first housing.

10. The coupler of claim 9 in which said seal mounted to said inner body of said second housing is positioned relative to said leading end of said plunger so that a seal is created between said inner section of said first housing and said inner body of said second housing before said actuator of said first housing moves said plunger to said open position.

11. The coupler of claim 10 in which said inner section of said first housing has an innermost edge which is first to engage said inner body of said second housing, said plunger actuator being spaced from said innermost edge of said first housing.

12. The coupler of claim 1 in which said locking mechanism comprises a lock collar coupled to said second housing, and a release member coupled to said lock collar, said release member including a ring movable within a slot formed in said lock collar and a release button operative to move said ring from a locked position to an unlocked position.

13. The coupler of claim 12 in which a portion of said lock collar is spaced from said exterior surface of said second housing forming a cavity, said inner section of said first housing being received within said cavity in the course of movement of said first housing relative to said second housing.

14. The coupler of claim 13 in which said ring of said release member extends into said cavity.

15. The coupler of claim 14 in which said inner section of said first housing is formed with an annular recess, at least a portion of said ring of said release member extending into said annular recess of said inner section of said first housing to lock said first and second housings together.

16. The coupler of claim 15 in which said release button is operative to disengage said at least a portion of said ring of said release member from said annular recess of said inner section of said first housing thus allowing said first housing to separate from said second housing.

17. The coupler of claim 14 further including a spring acting on said release member to urge said ring thereof into said cavity.

18. A coupler, comprising:
a first housing having an inner section, an outer section and a first passageway extending through said inner and outer sections, an actuator mounted to one of said inner and outer sections within said first passageway;
a second housing having a first end, a second end opposite said first end, a second passageway extending between said first and second ends, an interior surface defining said second passageway, an exterior surface spaced from said interior surface and a plunger movable within said second passageway between an open position and a closed position, said plunger having a leading end, a first seal mounted to one of said leading end of said plunger and said inner surface of said passageway at said first end of said second housing to create a seal between said leading end of said plunger and said first end of said second housing with said plunger in said closed position, a second seal extending outwardly from said exterior surface of said second housing;
said inner section of said first housing being moveable along said exterior surface of said second housing from said first end toward said second end thereof, said actuator of said first housing contacting said leading end of said plunger in the course of movement of said first housing relative to said second housing to move said plunger to said open position, said second seal of said second housing contacting and creating a seal with said inner section of said first housing prior to contact between said actuator and said plunger and prior to movement of said plunger to said open position; and
a locking mechanism coupled to said exterior surface of said second housing, said locking mechanism being effective to releasably connect said first housing and said second housing to one another with said plunger in said open position.

19. The coupler of claim 18 in which said second housing is formed with an inner body and an outer body which are connected to one another, said second passageway extending through said inner and outer bodies and having an inlet in said outer body and an outlet in said inner body.

20. The coupler of claim 19 in which said inner body is formed with a first shoulder adjacent said first end of said second housing, and said outer body is formed with a second shoulder spaced from said first shoulder.

21. The coupler of claim 20 in which said plunger is formed with a first radial projection which engages said first shoulder of said inner body when said plunger is in said closed position.

22. The coupler of claim 21 further including a spring extending along said plunger between said second shoulder of said outer body and a second radial projection of said plunger, said spring being effective to urge said plunger toward said closed position.

23. The coupler of claim 18 in which said locking mechanism comprises a lock collar coupled to said second housing, and a release member coupled to said lock collar, said release member including a ring movable within a slot formed in said lock collar and a release button operative to move said ring from a locked position to an unlocked position.

24. The coupler of claim 23 in which a portion of said lock collar is spaced from said exterior surface of said second housing forming a cavity, said inner section of said first housing being received within said cavity in the course of movement of said first housing relative to said second housing.

25. The coupler of claim 24 in which said ring of said release member extends into said cavity.

26. The coupler of claim 25 in which said inner section of said first housing is formed with an annular recess, at least a portion of said ring of said release member extending into said annular recess of said inner section of said first housing to lock said first and second housings together.

27. The coupler of claim 26 in which said release button is operative to disengage said at least a portion of said ring of said release member from said annular recess of said inner section of said first housing thus allowing said first housing to separate from said second housing.

28. The coupler of claim 25 further including a spring acting on said release member to urge said ring thereof into said cavity.
